(19) United States
(12) Patent Application Publication
(10) Pub. No.: US 2004/0124606 A1
(43) Pub. Date: Jul. 1, 2004

(54) Trailer hitch guide

(76) Inventor: Bud Wilcox, Grass Valley, CA (US)

Correspondence Address: Brian C. Kelly, Ltd., Attorney at Law, 555 South Center St., Reno, NV, 89501, US

(21) Appl. No.: 10/462,020

(22) Filed: Jun. 12, 2003

Related U.S. Application Data
(60) Provisional application No. 60/388,525, filed on Jun. 13, 2002.

(51) Int. Cl. B60D 1/00

(52) U.S. Cl. 280/477

(57) ABSTRACT

A method and apparatus for guiding a trailer hitch to meet a trailer in proximity to assist single handed hitching of a trailer to tow vehicle.

CLAIMS PRIORITY ON PROVISIONAL APPLICATION 60/388,525 (7736)

### BACKGROUND-FIELD OF INVENTION

This invention relates to generally to the field of trailer hitches and systems for guiding a vehicle to align its hitch with a trailer.

### DESCRIPTION OF THE PRIOR ART

There have been numerous triangular guides which align the hitch. All of these can force the trailer into alignment if the hitch is within certain parameters from the trailer. There has been one visual system, but that system fails by eliminating a visual element when one is close. The Applicant's invention overcomes the short comings of the prior art by providing a visual system that does not eliminate a tell-tale when in the vicinity of success, but rather indicates success visually.

### SUMMARY & OBJECTS OF THE INVENTION

A first object of the invention is to teach people how to operate heavy equipment in a safe environment.

A second object of the invention is to provide the opportunity for people to operate heavy equipment in a near real life environment.

A third object is to provide a learning situation where all parties start from “ground zero” and through development as a team the parties can produce a lasting achievement such as digging a trench or building a road.

### BRIEF DESCRIPTION OF DRAWINGS

FIG. 1 A side view of the apparatus.

FIG. 2 A side view of the system in situ.

### DETAILED DESCRIPTION OF PREFERRED EMBODIMENT

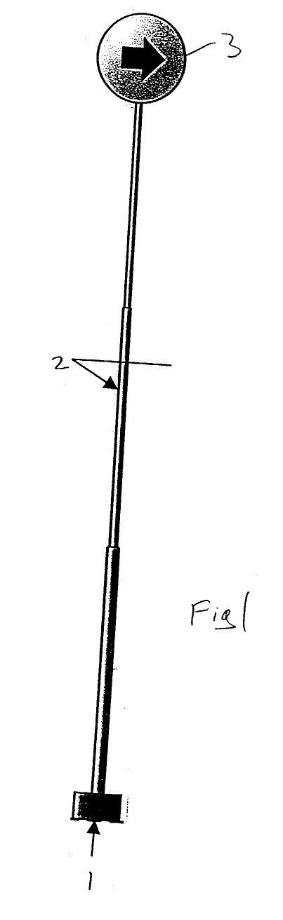

FIG. 1 shows a magnetic base 1 attached to a rod 2. The rod 2 should have enough height to be seen over the tail gate assembly when the vehicle operator is backing up. The top of the rod 2 has a ball 3. This can be a ball or black or character. It may be advantageous to have a diameter over 1 inch. The rod 2 in an alternate embodiment may be angled at some point.

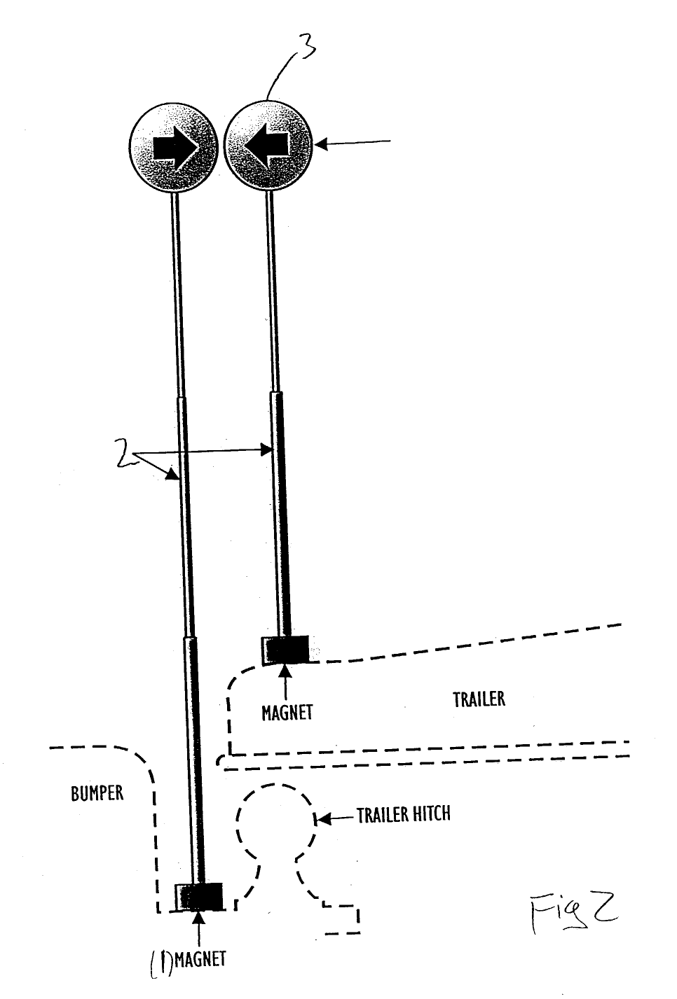

As shown in FIG. 2, one of the assemblies 4 is magnetically attached to the vehicle 5 and one is magnetically attached to the trailer 6.

The method of operation is after attachment the driver locates the two balls 3, then he simply guides his vehicle so that the two balls 3 touch. When they do, the trailer should be directly over the ball of the car and ready to be dropped thereon.

Obviously, numerous (additional) modifications and variations of the present invention are possible in light of the above teachings. It is, therefore, to be understood that within the scope of the appended claims, the invention may be practiced otherwise than as specifically described herein.

What is claimed is:

1. An apparatus for guiding a trailer to a hitch comprising a shaft member supported at an end by a base member and supporting an indicator means at an opposite end.

2. An apparatus as described in claim 1 wherein said base member comprises magnetic means for attaching said shaft member to a trailer.

3. An apparatus as described in claim 1 wherein said indicator means comprises means visible from a driver's seat of a vehicle.

4. An apparatus as described in claim 1 wherein said indicator means comprises a ball.

5. An apparatus as described in claim 1 wherein said shaft member comprises telescoping means to extend said shaft.

6. A method of aligning a trailer to a vehicle comprising a step of attaching indicator means to said trailer and to said vehicle, a step of viewing said indicator means from a driver's seat of said vehicle, a step of driving said vehicle in reverse and guiding said indicator means together such that when touching said trailer and a hitch of said vehicle are substantially aligned for attachment of said trailer to said hitch.

7. A method as described in claim 6 wherein said attachment means is attached to said hitch.

8. A method as described in claim 6 wherein indicator means comprises a shaft and magnetic attachment means.

9. A method as described in claim 6 further comprising a step of extending said indicator means.

10. A method as described in claim 1 wherein said shaft is metal material.

11. A method as described in claim 1 wherein said shaft is plastic material.
